(19) United States
(12) Patent Application Publication
(10) Pub. No.: US 2012/0259714 A1
(43) Pub. Date: Oct. 11, 2012

(54) ALLOCATION APPARATUS AND ALLOCATION METHOD

(75) Inventor: Naoto Sano, Tagata-gun (JP)

(73) Assignee: TOSHIBA TEC KABUSHIKI KAISHA, Tokyo (JP)

(21) Appl. No.: 13/430,946

(22) Filed: Mar. 27, 2012

(30) Foreign Application Priority Data
Apr. 11, 2011 (JP) 2011-087456

(51) Int. Cl. G06Q 50/12

(52) U.S. Cl. 705/15

(57) ABSTRACT

An allocation apparatus registers the data of the commodity selected as allocation object of the key button from the commodities displayed the names in association with the key button which is specified, then, if the existence of the commodity which is associated with the registered commodity is confirmed, takes the associated commodity as allocation object of next key button.

### CROSS-REFERENCE TO RELATED APPLICATION

This application is based upon and claims the benefit of priority from Japanese Patent Application No. 2011-087456, filed Apr. 11, 2011, the entire contents of which are incorporated herein by reference.

### FIELD

Embodiments described herein relate generally to an allocation apparatus and an allocation method for allocating a commodity to the key button for inputting specific commodity data.

### BACKGROUND

At present, the order accepting apparatus used in a restaurant is popularized which displays a key layout screen which consists a plurality of key button screen on a screen and accepts an order the commodity which is allocated to an operated key button. For example, the plurality of key button screens arranged in matrix in the key layout screen. The commodity of a menu is allocated in the area which displays each key button screen. When the commodity is allocated to each key button, operator repeats that every commodity is allocated to every key button, so requires a large amount of workload.

### BRIEF DESCRIPTION OF THE DRAWINGS

FIG. 1 is a view showing the whole structure of an order management system according to an embodiment;

FIG. 2 is a schematic diagram showing the structure of the menu data stored in a menu database according to the embodiment;

FIG. 3 is a block diagram showing the main components of the POS terminal of the order management system according to the embodiment;

FIG. 4 is a view illustrating a key layout according to the embodiment;

FIG. 5 is a schematic diagram showing the primary storage area formed in the RAM of the POS terminal according to the embodiment;

FIG. 6 is a flow chart showing the processing executed by the CPU of the POS terminal in accordance with an allocation program in the embodiment;

FIG. 7 is a flow chart showing the processing of a menu allocation processing shown in FIG. 6;

FIG. 8 is a schematic diagram showing the state of the menu allocation screen before the allocation is carried out;

FIG. 9 is a schematic diagram showing the state of the menu allocation screen after the allocation is carried out;

FIG. 10 is a schematic diagram showing the structure of the menu data stored in the menu database according to a second embodiment;

FIG. 11 is a schematic diagram showing the association table formed in the RAM of the POS terminal according to the second embodiment;

FIG. 12 is a flow chart showing the processing of the menu allocation executed by the CPU of the POS terminal in accordance with an allocation program in the second embodiment.

### DETAILED DESCRIPTION

According to one embodiment, an allocation apparatus, comprising: an allocation information storage unit, a commodity data storage unit, an associating commodity information storage unit, a key button specifying unit, a commodity name display unit, a selection commodity registration unit and an allocation commodity specifying unit. The allocation information storage unit configured to store a key button allocation information for allocating the key button which operate to select and input a commodity. The commodity data storage unit configured to store the name of each commodity corresponding to the data specifying the commodity which is allocated to each key button. The associating commodity information storage unit configured to store the information showed the associating with other commodity for each commodity. The key button specifying unit configured to specify the key button which is allocated the commodity stored in the commodity data storage unit. The commodity name display unit configured to display for invoking the name of the commodity stored in the commodity data storage unit. The selection commodity registration unit configured to register the data of the commodity selected as allocation object of the key button from the commodities displayed the names by the commodity name display unit in association with the key button specified by the key button specifying unit. The allocation commodity specifying unit configured to, if the existence of the commodity which is associated with the commodity registered by the selection commodity registration unit is confirmed according to the information stored in the associating commodity information storage unit, take the associated commodity as allocation object of next key button.

An embodiment of the allocation apparatus is described in detail below with reference to accompanying drawings.

This embodiment is the case that makes the POS terminal of an order management system in a restaurant function as the allocation apparatus by executing a pre-installed allocation program.

### First Embodiment

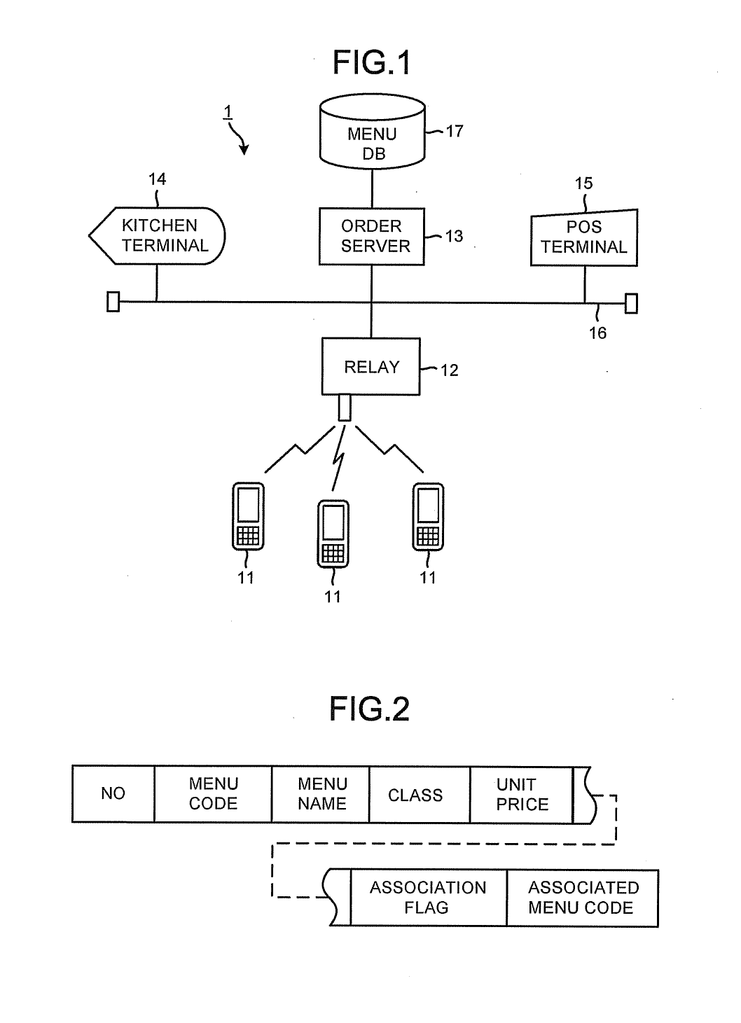

FIG. 1 is a view showing the whole structure of an order management system according to this embodiment. The order management system 1 comprises a plurality of handy terminals 11, a relay 12, an order server 13, a kitchen terminal 14 and a POS terminal 15. Each handy terminal 11 with a built-in a ratio circuit may communicate with the relay 12 wirelessly. The order server 13 may communicate with the relay 12, the kitchen terminal 14 and the POS terminal 15 wiredly via a network 16.

The numbers of the relay 12, the kitchen terminal 14 and the POS terminal 15 are not limited to be one. It may also be allowed that more than two relays 12, kitchen terminals 14 and POS terminals 5 are respectively connected with the network 16 to form the order management system 1.

The handy terminal 11 includes a keyboard and a display unit. The display unit is a touch panel. The handy terminal 11, which is a form of an order accepting apparatus, is carried by the greeter in a shop. Moreover, if an order for the commodities in a menu is received from a customer, then the greeter operates the keyboard or touch panel to input the data (menu code and order number) of the commodities in the order. The input order data is wirelessly sent to the order server 13 via the relay 12.

The order server 13 includes a menu database 17. The data of each commodity in the menus of the restaurant formed this system (hereinafter referred to as menu data) is stored in the menu database 17.

The structure of the menu data is schematically shown in FIG. 2. As shown in FIG. 2, the menu data includes a record number, a menu code, a menu name, a class code, a unit price, an association flag and an associated menu code. The record number is the number peculiar to the menu data, which is the serial number of starting from one. The menu code is a code for identifying each commodity in a menu. The menu name is the name of the menu of the commodity specified according to the menu code. The class code is a code for identifying the class to which the commodity specified according to the menu code. The class includes, for example, Western-style food, Japanese food, Chinese food, snack and beverage. The unit price is the price per piece of the commodity specified according to the menu code.

The association flag is used to identify whether or not there is a commodity which associate with the commodity specified according to the menu code. In this embodiment, the associating commodity is defined with respect to a commodity that belongs to the same class but processed as a different commodity. The class which has a hot commodity and an iced commodity falls under the associating commodity, for example, the class of hot coffee and iced coffee, lemon tea and iced lemon tea, hot milk and iced milk. The menu code of an existing associating commodity is added in menu data as an associated menu code.

Here, the menu database 17 comprises a commodity data storage unit and an associating commodity information storage unit.

The order server 13, if acquiring the order data sent from the handy terminal 11 through the relay 12, generates an order accepting data with reference to the menu database 17 and stores the generated order accepting data per customer. The kitchen terminal 14 generates a cooking instruction data according to the order accepting data and informs the cooker of the cooking instruction data by displaying or printing. The POS terminal 15 calculates the expense of the commodity consumed by a customer according to the order accepting data and executes an accounting process according to the expense data and the amount paid by the customer.

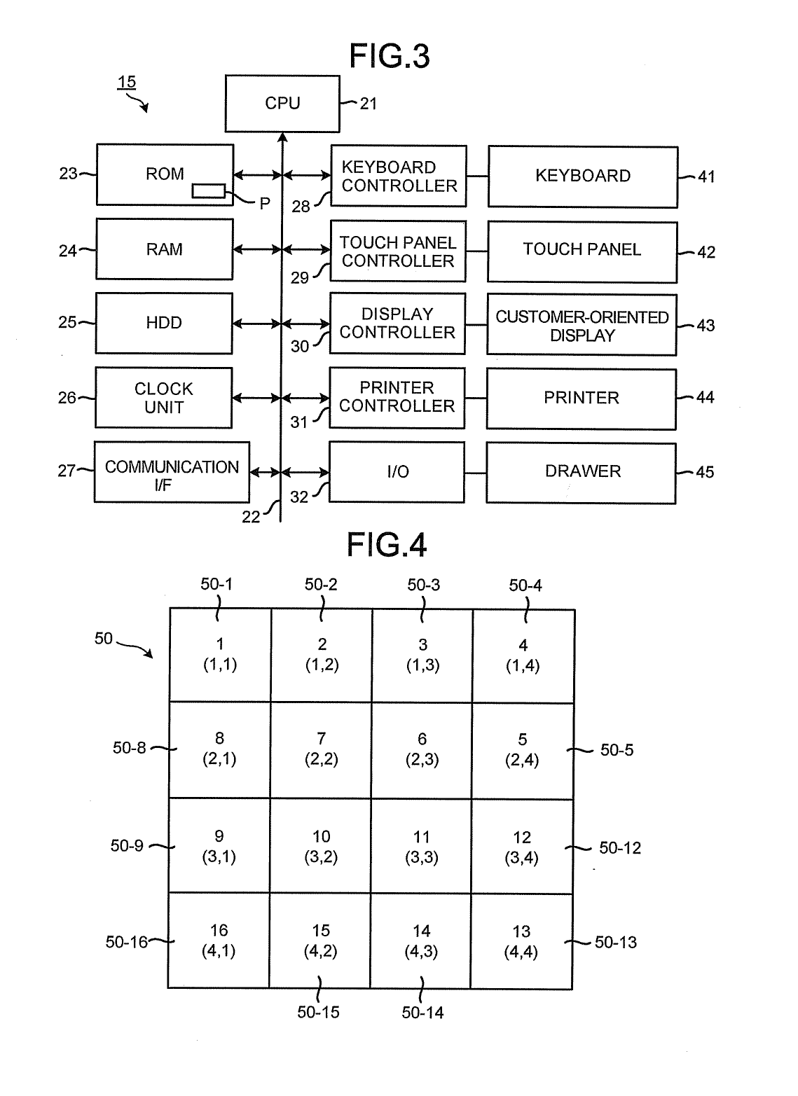

FIG. 3 is a block diagram showing the main components of the POS terminal of the order management system 15. The POS terminal 15 includes a CPU 21 as the central processor of a computer, the CPU 21 is connected with an ROM (Read Only Memory) 23, an RAM (Random Access Memory) 24, an HDD (Hard Disk Drive) 25, a clock unit 26, a communication interface 27, a keyboard controller 28, a touch panel controller 29, a display controller 30, a printer controller 31 and an I/O (Input/Output) port 32 via a bus line 22 includes an address bus line and a data bus line, thereby comprises the control circuit of the POS terminal 15.

The keyboard controller 28 acquires a key signal from a keyboard 41 to determine a key to be operated. The touch panel controller 29 enables a screen to be display on a touch panel 42 and detects the coordinate of the position where the screen is touched. The display controller 30 controls the display unit of a customer-oriented display unit 43. The printer controller 31 controls a printer 44 to issue a receipt. The I/O port 32 outputs an opening signal to a drawer 45 for receiving a cash, etc.

The POS terminal 15, in addition to above accounting function, further includes a function of allocating commodities for a key layout. This function includes a function of generating a screen data of key layout 50 which displayed on the touch panel of the handy terminal 11 and sending the screen date to each handy terminal 11, executed by an allocation program P stored in the ROM 23.

The key layout 50 mentioned in this embodiment is shown in FIG. 4. In the key layout 50, 16 rectangular key buttons 50-1 to 50-16 are configured into the shape a 4*4 matrix. Moreover, the four key buttons 50-1 to 50-4 in the first row are orderly numbered, from left to right, 1, 2, 3 and 4, the four key buttons 50-5 to 50-8 in the second row are orderly numbered, from right to left, 5, 6, 7 and 8, the four key buttons 50-9 to 50-12 in the third row are orderly numbered, from left to right, 9, 10, 11 and 12, and the four key buttons 50-13 to 50-16 in the fourth row (the bottom row) are orderly numbered, from right to left, 13, 14, 15 and 16, so that the numbers added for the key buttons in each row are ascended in reverse direction.

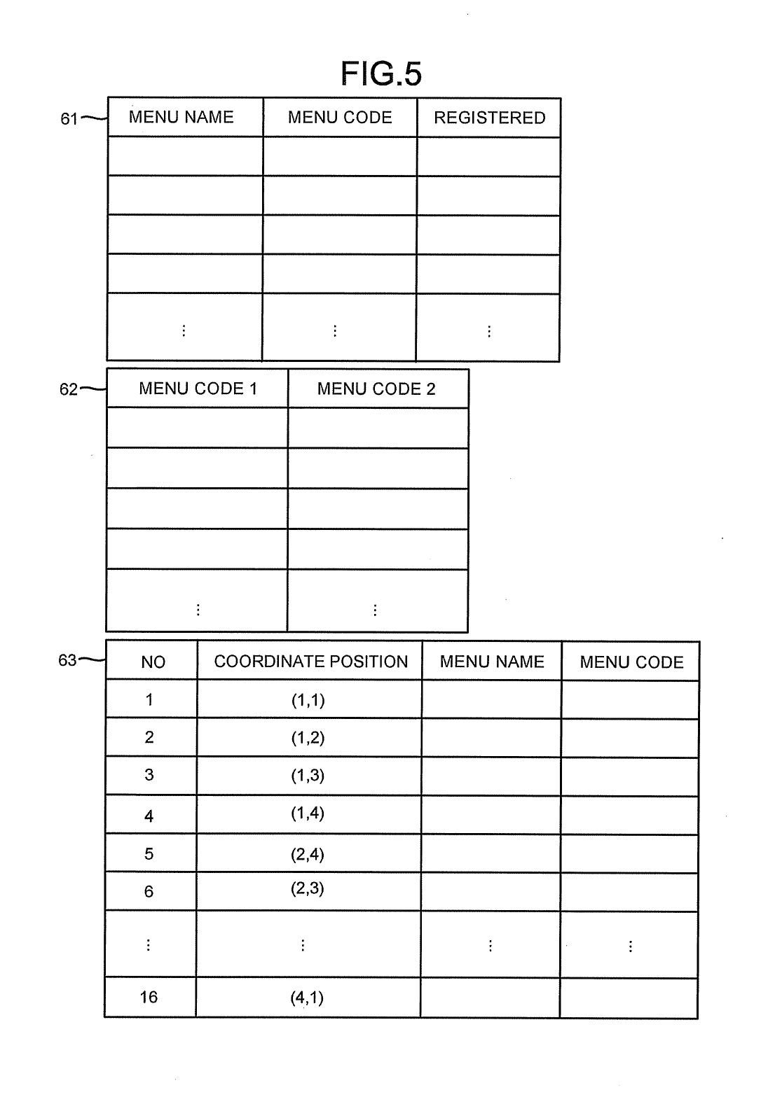

In order to achieve the commodity allocation function, the POS terminal 15 includes the storage areas 61, 62 and 63 shown in FIG. 5 in the RAM 24.

The storage area 61 is an allocation candidate table, which includes an area for storing the menu names and the menu codes of the commodities that are assigned to the key buttons 50-1 to 50-16 in the key layout 50 as candidates along with registration completion flags. The registration completion flag is ‘0’ if a corresponding commodity is not assigned to a key button and is changed to ‘1’ if the commodity is assigned.

The storage area 62 is an association table, which includes an area for storing the menu codes of the commodities associated with the commodities to be assigned as candidates.

The storage area 63 is a layout table serving as an allocation information storage unit. The layout table 63 corresponding to the numbers 1-16 of the key buttons 50-1 to 50-16 in the key layout 50 includes an area for storing the position coordinates (X, Y) of the key buttons 50-1 to 50-16, menu names and menu codes. In FIG. 4, the position coordinate of the top leftmost key button 50-1 is set to be (1, 1), the vertical coordinate of each key button at the right side of the former one is increased by 1, and the horizontal coordinate of each key button below the former one is increased by 1, and consequentially, the coordinate of the bottom rightmost key button 50-13 is changed to (4, 4).

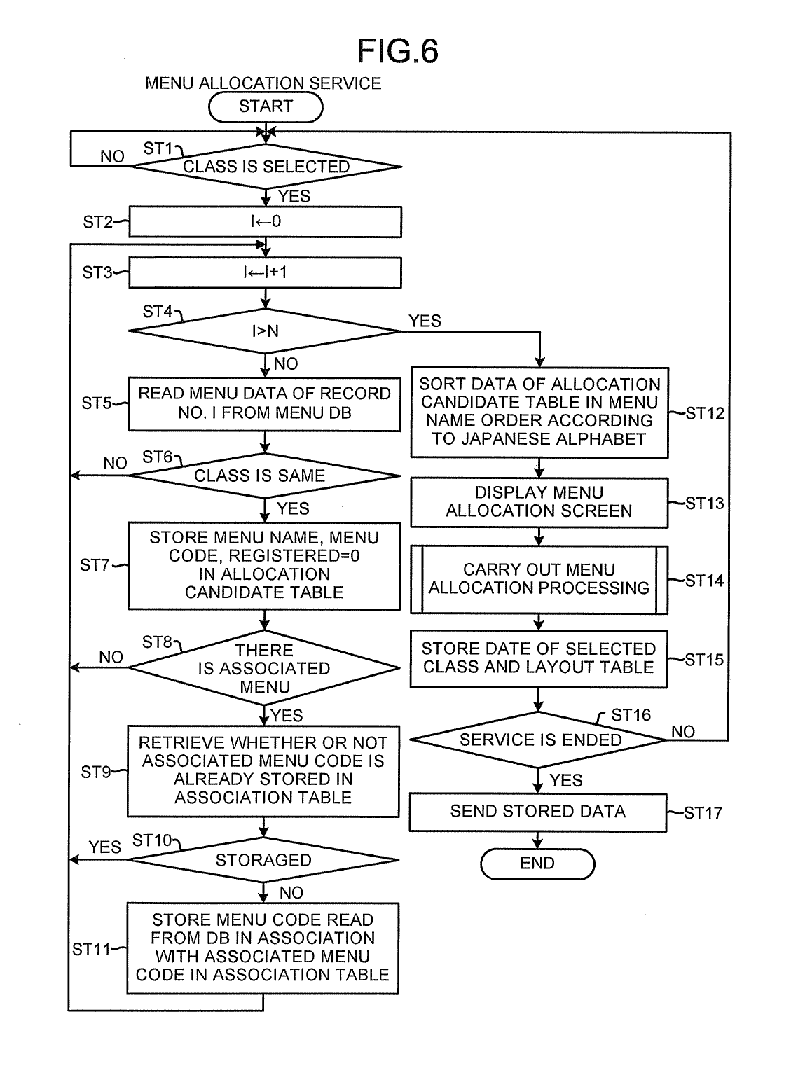

In the POS terminal 15, the allocation program P is executed if the commodity allocation service is selected from the service menus for the key layout, so that the CPU 21 may execute the following processes shown in the flow chart of FIG. 6.

First, the CPU 21 waits to select a commodity class (ST 1). For example, a class is optionally selected from a list of classes including Western-style food, Japanese food, Chinese food, snack and beverage display on the touch panel 42 (ST 1: Yes), then the CPU 21 temporarily resets the number count i to ‘0’ (ST 2). Next, the CPU 21 stops accumulating the number count i when the number count i is equal to 1 (ST 3) and then determines whether or not the number count i exceeds the total number N of the menu data registered in the menu database 17 (ST 4).

If the number count i is not greater than the total number N (ST 4: No), the CPU 21 reads No. i menu data from the menu database 17. Moreover, the CPU 21 determines whether or not the class code of the read menu data is the same as that of the class selected in ST1 (ST 6).

If the class codes are different (ST 6: No), the CPU 21 stops accumulating the number count i when the number count i is equal to 1 (ST 3) and executes the processes following ST 4 again.

Otherwise (ST 6: Yes), the CPU 21 registers the menu name and the menu code of the read menu data and a registration completion flag ‘0’ in the allocation candidate table 61 (ST 7: allocation candidate storage unit).

Next, the CPU 21 checks the association flag of the read menu data (ST 8). If the association flag is ‘0’, that is, there is no associated menu (ST 8: No), the CPU 21 stops accumulating the number count i when the number count i is equal to 1 (ST 3) and executes the processes following ST 4 again.

If the association flag is ‘1’, that is, there is an associated menu (ST 8: Yes), the CPU 21 retrieves the association table 62 to determine whether or not the code of the associated menu of the read menu data is stored in the association table. If the code of the associated menu of the read menu data is stored in the association table (ST 10: Yes), the CPU 21 stops accumulating the number count i when the number count i is equal to 1 (ST 3) and executes the processes following ST 4 again.

Here, if the code of the associated menu of the read menu data is not stored in the association table (ST 10: No), the CPU 21 stores the menu code of the read menu data and the code of the associated menu in the menu code areas 1 and 2 of the association table 62 (ST 11). Then, the CPU 21 stops accumulating the number count i when the number count i is equal to 1 (ST 3) and executes the processes following ST 4 again.

In this way, the CPU 21 repeats executing processes ST 5-ST 11 until the number count i exceed the total number N of the menu data. Moreover, if the number count i exceed the total number N of the menu data (ST 4: Yes), the CPU 21 orders the registered data in the allocation candidate table 61 in accordance with the order of Japanese basic sounds (ST 12).

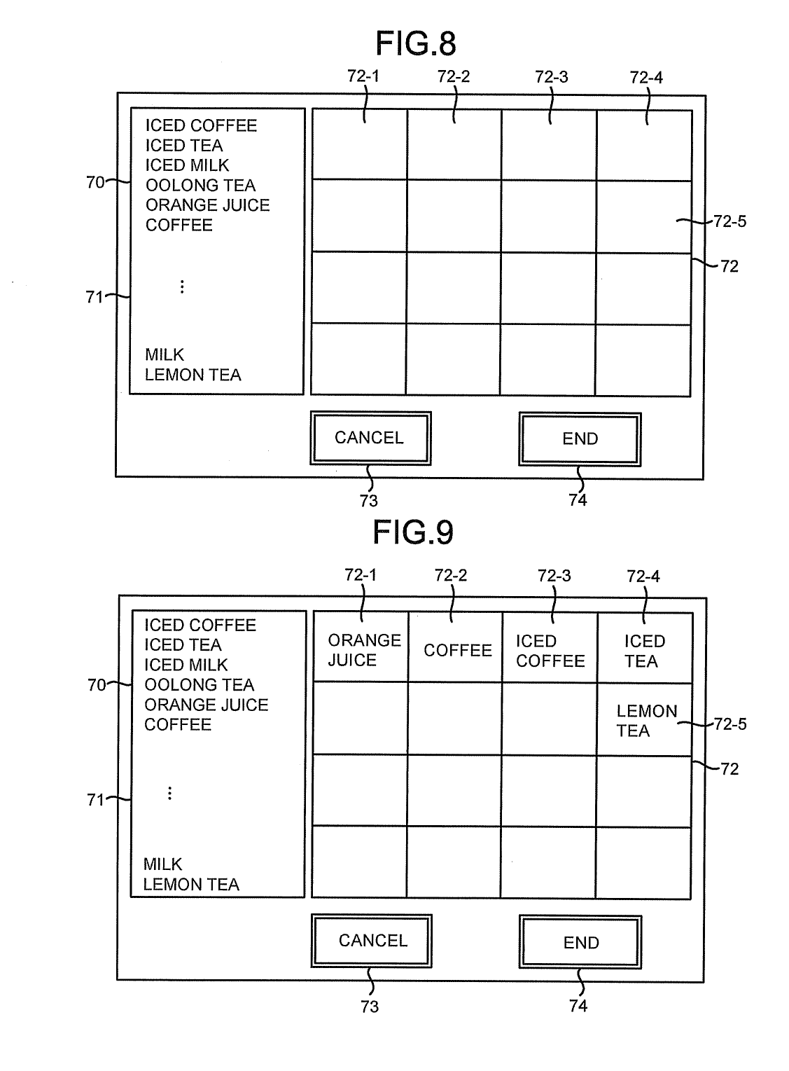

Then, the CPU 21 display units a menu allocation screen 70 on the touch panel 42 (ST 13: screen display unit). FIG. 8 shows an example of the menu allocation screen 70. As shown in FIG. 8, an allocation candidate list 71, a key layout screen 72, a cancel button 73 and an end button 74 are display on the menu allocation screen 70. The list of the menu names of the commodities registered in the allocation candidate table 61 are displayed in the allocation candidate list 71 (commodity name display unit). The key layout screen 72 is the screen of the key layout 50.

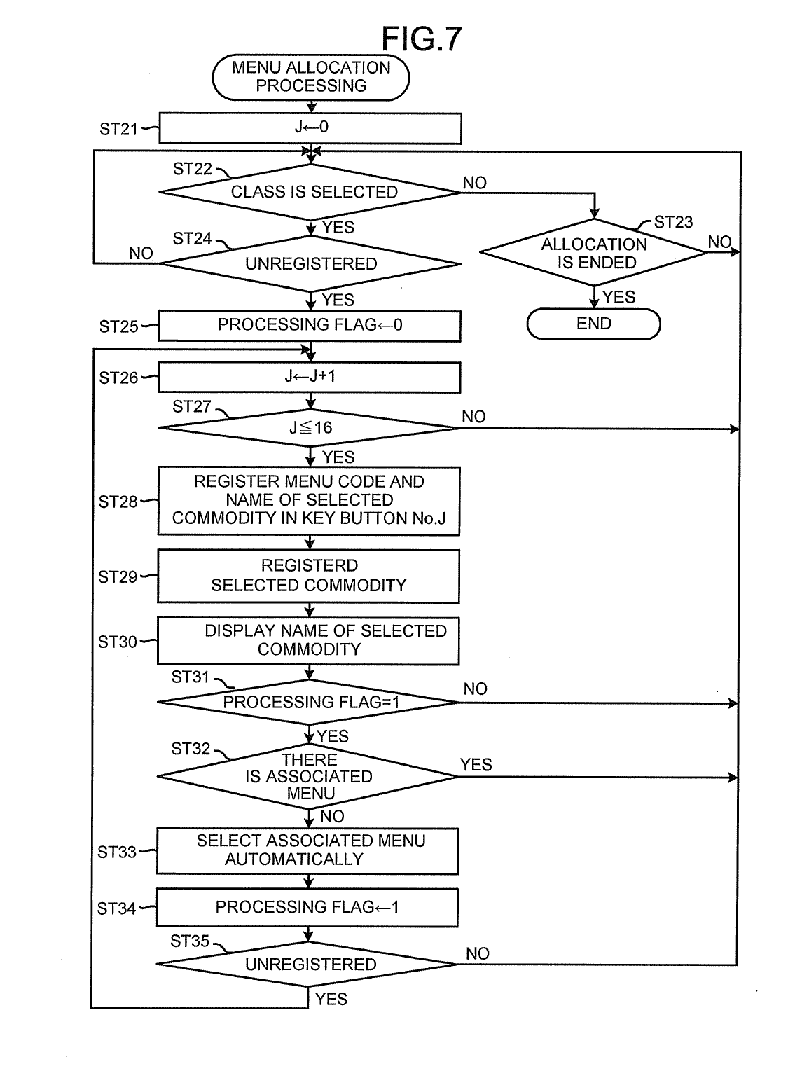

If the menu allocation screen 70 is displayed, then the CPU 21 carries out the specific menu allocation processing shown in FIG. 7.

First, the CPU 21 resets a number count j to 0 (ST 21). Next, the CPU 21 waits to select any commodity from the allocation candidate list 71 (ST 22) or input the end button 74 (ST 23)

If an allocation candidate commodity is selected (ST 22: YES), the CPU 21 checks the registration completion flag of the selection commodity registered in the allocation candidate table 61 (ST 24). Moreover, if the registration completion flag is ‘1’, that is, the registration is completed (ST 24: No), the CPU 21 waits to select the next commodity (ST 22) or input the end button 74 (ST 23).

If the registration completion flag is ‘0’, that is, the selection commodity is not registered (ST 24: Yes), the CPU 21 changes a processing flag f to be ‘0’. Then, the CPU 21 stops accumulating the number count j when the number count j is equal to 1 (ST 26: key button specifying unit). Moreover, the CPU 21 determines whether or not the number count j is smaller than the number ‘16’ of the key buttons in the key layout 50 (ST 27)

If the number count j is smaller than the number ‘16’ of the key buttons in the key layout 50 (ST 27: Yes), the CPU 21 reads the menu code and the menu name of the selection commodity from the allocation candidate list 71 and registers the read menu code and menu name in the No. j area of the layout table (ST 28: selection commodity registration unit). Moreover, the CPU 21 changes the registration completion flag of the selection commodity from 0 to 1 (ST 29). Further, the CPU 21 display units the menu name of the selection commodity in the No. j key button in the key layout screen 72 (ST 30: allocation commodity display unit).

Next, the CPU 21 determines whether or not the processing flag is ‘1’ (ST 31). If not (ST 31: No), the CPU 21 retrieves the association table 62 to determine whether or not the menu code of the selection commodity is in the association table 62 (ST 32). If the menu code of the selection commodity is not in the association table 62 (ST 32: No), the CPU 21 waits to select the next commodity (ST 22) or input the end button 74 (ST 23).

If the menu code of the selection commodity is in the association table 62 (ST 32: Yes), the CPU 21 selects the menu code associated with the menu code of the selection commodity from the association table 62 (ST 33: allocation commodity specifying unit). Further, the CPU 21 changes the processing flag to be ‘1’ (ST 34).

Then, the CPU 21 checks the registration completion flag of the commodity specified in the associated menu code (ST 35). Here, if the registration completion flag is ‘1’, that is, if the registration is completed (ST 35: No), the CPU 21 waits to select the next commodity (ST 22) or input the end button 74 (ST 23).

If the registration completion flag is ‘0’, that is, no registration is carried out (ST 35: Yes), the CPU 21 returns to execute ST 26. Moreover, if the number count j is just accumulated to 1, then the CPU 21 determines whether or not the number count j is smaller than the number ‘16’ of the key buttons in the key layout screen 72 (ST 27).

If the number count j is smaller than the number ‘16’ of the key buttons in the key layout screen 72 (ST 27: Yes), the CPU 21 registers the menu code and the menu name of the commodity selected from the association table 62 in the No. j area of the layout table 63 (ST 28: associating commodity registration unit). Moreover, the CPU 21 changes the registration completion flag of the selection commodity from 0 to 1 (ST 29). Further, the CPU 21 display units the menu name of the selection commodity in the No. j key button in the key layout screen 72 (ST 30: allocation commodity display unit).

Moreover, if the registration completion flag is ‘1’ (ST 31: Yes), that is, if the number count j exceeds the number ‘16’ of the key buttons in the key layout screen 72 (ST 27: No), the CPU 21 waits to select the next commodity (ST 22) or input the end button 74 (ST 23).

If the end button is input (ST 23: Yes), the CPU 21 ends the menu allocation processing which is described in FIG. 6.

After the menu allocation processing is ended, the CPU 21 stores the code of the class selected in ST 1 and the data in the layout table 63 in the HDD 25 (ST 15). Next, the CPU 21 determines whether or not the completion of the service is announced (ST 16). If there is no announcement on the completion of the service, the CPU 21 returns to execute ST 1. Moreover, if the code of the next class is selected, then the CPU 21 repeats executing processes ST 2-ST 15.

If the completion of the service is announced (ST 16: No), the CPU 21 sends the class code and the data of the layout table 63 stored in the HDD 25 via the communication interface 16 (ST 17). The sent data is wirelessly sent to each handy terminal 11 via the relay 12.

The allocation of the commodities in the class ‘beverage’ for the key buttons 50-1 to 50-16 in the key layout 50 is exemplarily described below. In this case, the user of the POS terminal starts a commodity allocation service for the key button allocation and selects a class ‘beverage’. As a result, in the POS terminal 15, the menu names and the menu codes of the commodities belonging to the class ‘beverage’ are extracted from the menu database 17 and registered in the allocation candidate table 61. Besides, if there is a commodity associated with an extracted commodity, then the menu codes of the extracted commodity and the associating commodity are registered in the association table 62 in pair.

Then, the data registered in the allocation candidate table 61 is ordered according to the order of the basic Japanese sounds of the menu names. Moreover, the menu allocation screen 70 shown in FIG. 8 is display on the touch panel 42.

First, the commodity registered in the No. 1 key button 72-1 in the key layout screen 72 is selected by the operator from the allocation candidate list 71. For example, assuming the currently selection commodity is ‘orange juice’, the menu name and the menu code of the commodity ‘orange juice’ are stored in the No. 1 area of the layout table 63. Besides, as shown in FIG. 9, the menu name of the commodity ‘orange juice’ is display in the key button 72-1 of the key layout screen 72.

Here, there may be no commodity associated with the commodity ‘orange juice’. In this case, the operator selects, from the allocation candidate list 71, the commodity registered in the No. 2 key button 72-2 in the key layout screen 72. For example, assuming the currently selection commodity is ‘coffee’. Then, the menu name and the menu code of the commodity ‘coffee’ are stored in the No. 2 area of the layout table 63. Besides, as shown in FIG. 9, the menu name of the commodity ‘coffee’ is display in the key button 72-2 of the key layout screen 72.

Here, as there is commodity ‘iced coffee’ associated with the commodity ‘coffee’, the menu name and the menu code of the commodity ‘iced coffee’ are stored in the No. 3 area 72-3 of the layout table 63. Besides, as shown in FIG. 9, the menu name of the commodity ‘iced coffee’ is display in the key button 72-3 of the key layout screen 72, that is, in the key button at the right side of the key button 72-1 where the commodity ‘coffee’ is registered.

Next, assuming the operator selects, from the allocation candidate list 71, the commodity ‘iced tea’ registered in the No. 4 key button 72-4 in the key layout screen 72, the menu name and the menu code of the commodity ‘iced tea’ are stored in the No. 4 area of the layout table 63. Besides, as shown in FIG. 9, the menu name of the commodity ‘iced tea’ is display in the key button 72-4 of the key layout screen 72.

Here, as there is commodity ‘lemon tea’ associated with the commodity ‘iced tea’, the menu name and the menu code of the commodity ‘lemon tea’ are stored in the No. 5 area 72-5 of the layout table 63. Besides, as shown in FIG. 9, the menu name of the commodity ‘iced tea’ is display on the key button 72-5 of the key layout screen 72, that is, on the key button below the key button 72-4 where the commodity ‘iced tea’ is registered.

As stated above, in this embodiment, if either of a hot commodity and a cold commodity is allocated to some one of these key buttons of the key layout screen 72, then the commodity associated with the allocated commodity is allocated to another key button automatically. So the workload of the operator may reduce compared this embodiment with the traditional way that repeat an allocation of one commodity for one key button. Moreover, the associating commodity is inevitably allocated to a neighboring key button, thus may avoid that two commodities belonging to the same class but treated as different commodities are allocated to apart key button from each other.

### Second Embodiment

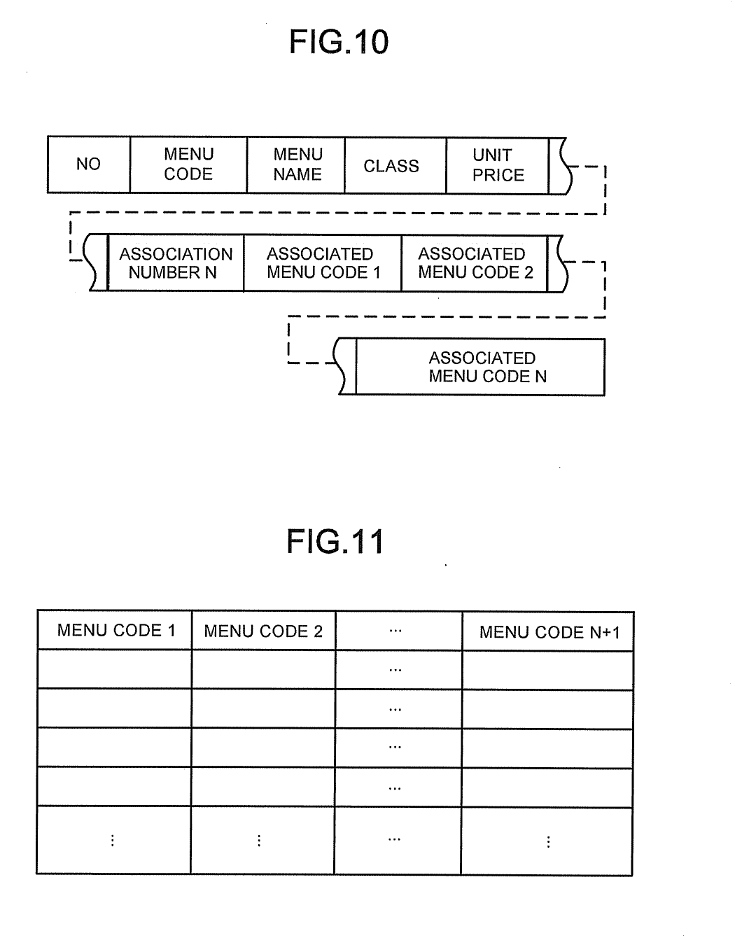

The first embodiment is the case that associated commodities are limited to classify into two classes such as the hot commodity and the cold commodity. The second embodiment is the case that associated commodities are classified into at least three classes such as L-size commodity, M-size commodity and S-size commodity. In this case, as shown in FIG. 10, the menu data includes an association number n and an associated menu code that the number of it is the same as that of the association number n in addition to a record number, a menu code, a menu name, a class code and a unit price. For example, the association number count is 2 if there are two classes such as an M-size commodity and an S-size commodity as the commodity associated with an L-size commodity. Further, the association number count is 4 if there are three classes such as a 2L-size commodity, a 3L-size commodity, an M-size commodity and an S-size commodity as the commodity associated with an L-size commodity. The association number count is 0 if there is no associating commodity.

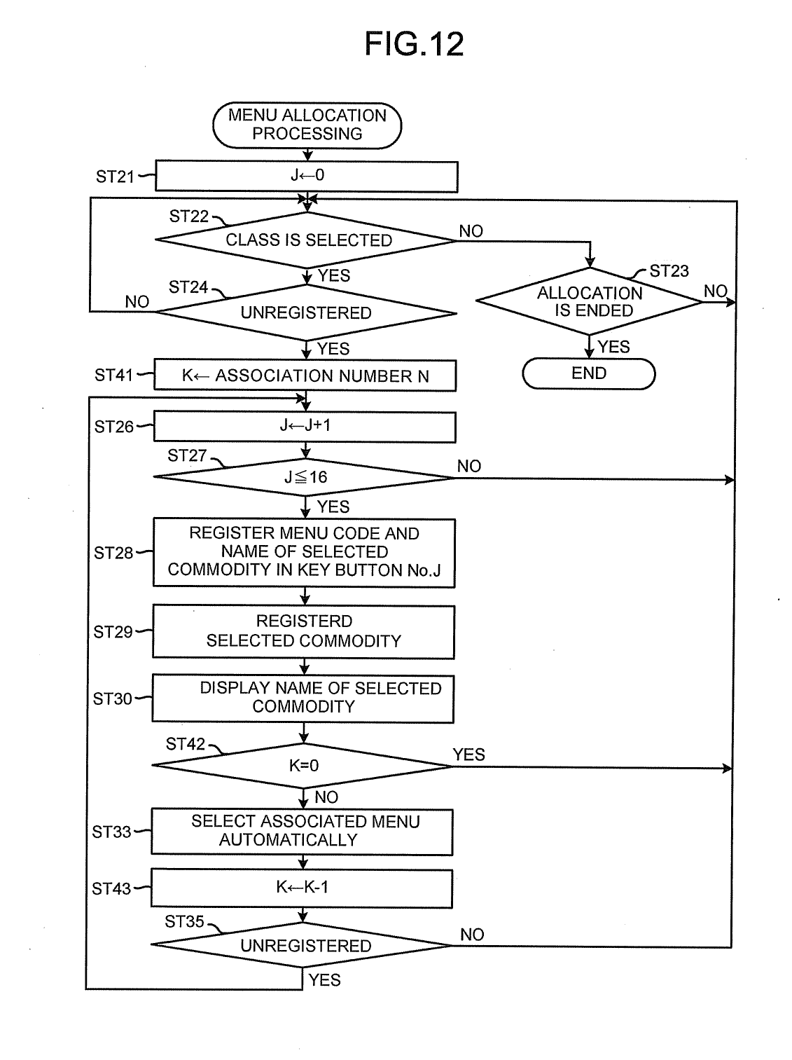

As shown in FIG. 11, the association table 62 includes an area for storing n+1 associated menu codes. FIG. 12 is a flow chart showing the processing executed by the CPU 21 when an allocation program P is executed. Further, the processes shown in FIG. 12 identical to those shown in FIG. 7 and executed in first embodiment are represented with the same symbols and are therefore not repeatedly described here.

The second embodiment is different from the first embodiment in the following three processes.

The first one: in ST 24, if the registration completion flag of the selection commodity registered in the allocation candidate table 61 is checked and the result is ‘0’, that is, the case that the selection commodity is not registered (ST 24: Yes), the first embodiment and the second embodiment differ from each other in their processes. Then, the association number n is set as subtraction count K (ST 41) in second embodiment, while ‘0’ is set as the processing flag f (ST 25) in first embodiment.

The second one: in ST 30, after the menu name of the selection commodity is displayed in the key button No. j of the key layout screen 72, the first embodiment and the second embodiment differ from each other in their processes. In this case, the CPU 21 determine whether or not the processing flag is ‘1’ (ST 31), if not is ‘1’ (ST 31: No), the CPU 21 retrieves to determine whether or not the menu code of the selection commodity exist in the association table 62 (ST 32) in first embodiment, while the CPU 21 determine whether or not the subtraction count K is ‘0’ (ST 42), if the subtraction count K is ‘0’, the CPU 21 waits whether or not to select a next commodity (ST 22) or input an end button 74 (ST 23), if the subtraction count K is more than ‘0’, select a menu code associated with the menu code of the selection commodity from the association table 62 (ST 33) in second embodiment. The third one: in ST 33, after the menu code associated with that of the selection commodity is selected from the association table 62, the first embodiment and the second embodiment differ from each other in their processes. In second embodiment, subtract ‘1’ from the subtraction count K (ST 43), while in first embodiment, the processing flag is changed to be ‘1’ (ST 34).

In this second embodiment, for example, if an M-size commodity and an S-size commodity are associated with an L-size commodity and the L-size commodity is selected from the allocation candidate list 71, then the commodity of the same class as the M-size commodity and the commodity of the same class as the S-size commodity are automatically allocated to two key buttons that are set follow by setting the key button in the key layout that the L-size commodity is allocated. Thus, the workload of the operator responsible for commodity allocation may be relieved.

The variation embodiments of the embodiments above are described below.

For example, in the embodiments above, it is assumed that the key layout 50 is the matrix state of a rectangle, however, it may be appreciated that the present invention is applicable to a commodity allocation for the key buttons in a key layout in other shapes. In these cases, for example, an associating commodity may be automatically allocated to a nearest blank key button to the key button that the selection commodity is allocated.

Further, in the embodiments above, the data of the key layout 50 generated by the POS terminal 15 is sent to each handy terminal 11, however, the data of the key layout 50 may also be written into a nonvolatile storage medium and then read by each handy terminal 11, thereby setting the data of the key layout 50 in each handy terminal 11.

Further, in the embodiments above, an allocation unit used for the key layout displayed on the touch panel is exemplarily described, however, the present invention may also applicable for an allocation unit used for a key layout in which a key button is selectively input by operating a pointer on a screen with a pointing device.

Further, it is assumed in the embodiments above that an allocation program P for achieving the functions of the present invention is pre-stored in the ROM 23 of the POS terminal 15. However, the present invention is not limited to this case, the same program may also be downloaded to the POS terminal 15 via a network, or the same program recorded in a recording medium may also be installed in the POS terminal 15. If the recording medium may store programs like a CD-ROM and a memory card and is readable to a unit, then the form of the recording medium is unlimited. Further, the functions achieved by an installed or downloaded program may also be achieved by cooperating with an OS (Operating System) in the unit.

Further, after installed with the same program, a personal computer may also serve as a dedicated allocation unit.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An allocation apparatus, comprising:
an allocation information storage unit configured to store a key button allocation information for allocating the key button which operate to select and input a commodity;
a commodity data storage unit configured to store the name of each commodity corresponding to the data specifying the commodity which is allocated to each key button;
an associating commodity information storage unit configured to store the information showed the associating with other commodity for each commodity;
a key button specifying unit configured to specify the key button which is allocated the commodity stored in the commodity data storage unit;
a commodity name display unit configured to display for invoking the name of the commodity stored in the commodity data storage unit;
a selection commodity registration unit configured to register the data of the commodity selected as allocation object of the key button from the commodities displayed the names by the commodity name display unit in association with the key button specified by the key button specifying unit; and
an allocation commodity specifying unit configured to, if the existence of the commodity which is associated with the commodity registered by the selection commodity registration unit is confirmed according to the information stored in the associating commodity information storage unit, take the associated commodity as allocation object of next key button.

2. The allocation apparatus according to claim 1, further comprising:
an associating commodity registration unit configured to register the data specified as allocation object of next key button by the allocation commodity specifying unit, associated with unregistered key button which is allocated to near key button which is satisfied by the key button satisfying unit.

3. An allocation apparatus, comprising:
a layout table, which is associated with the key button identification information for identifying the key buttons in a key layout formed by a plurality of key buttons and includes an area for storing the data of the commodities allocated to the key button;
an allocation candidate storage unit configured to store the data of each commodity as a candidate of an allocation to the key button of the key layout;
a selection commodity registration unit configured to register the data of the commodity selected from the commodities which are the allocation candidate in the area of the layout table associated with the identification information of the key button specified one of the key buttons in the key layout; and
an associating commodity registration unit configured to register, if there is a commodity that is associated with the commodity which is registered a data by the selection commodity registration unit in the commodities which are the allocation candidate, the data of the associating commodity in the area of the layout table associated with the identification information of the key button that the data of which is not registered from the key button of the key layout.

4. The allocation apparatus according to claim 3, further comprising:
an screen display unit configured to display unit the screen of the key layout; and
an allocation commodity display unit configured to display the commodity data contained in the area which is associated with the identification information of the key button in the layout table, within each key button in the key layout screen.

5. The allocation apparatus according to claim 3, wherein
the key layout is that a plurality of key button are mapped into matrix state; and
the associating commodity registration unit registers the data of the commodity associated with the area of the layout table which is associated with the identification information of the key button which is unregistered and is adjacent to the key button registered by the selection commodity registration unit.

6. The allocation apparatus according to claim 4, wherein
the key layout is that a plurality of key button are mapped into matrix state; and
the associating commodity registration unit registers the data of the commodity associated with the area of the layout table which is associated with the identification information of the key button which is unregistered and is adjacent to the key button registered by the selection commodity registration unit.

7. An allocation method for allocating a key button allocation information to an allocation information storage unit which stores the key button allocation information for allocating the key button which operate to select and input a commodity, including:
specifying the key button allocated the commodity which stored in a commodity data storage unit which stores the name of each commodity corresponding to the data specifying the commodity;
displaying for invoking the name of the commodity stored in the commodity data storage unit;
registering the data of the commodity selected as allocation object of the key button from the commodities displayed the names by the commodity name display unit in association with the key button specified by the key button specifying unit; and
taking the associated commodity as allocation object of next key button if the existence of the commodity which is associated with the commodity registered by the selection commodity registration unit is confirmed according to the information stored in the associating commodity information storage unit.
